(19) United States
(12) Patent Application Publication
(10) Pub. No.: US 2021/0317897 A1
(43) Pub. Date: Oct. 14, 2021

(54) PARTIAL REVERSE CLUTCH ASSEMBLY WITH AN ANNULAR SWING BODY

(71) Applicant: LEXMARK INTERNATIONAL, INC., Lexington, KY (US)

(72) Inventors: GENRI SOLANO BELARMINO, CEBU (PH); DARREN ADAM KEESE, LEXINGTON, KY (US); DANIEL LEE THOMAS, LEXINGTON, KY (US)

(21) Appl. No.: 17/225,398

(22) Filed: Apr. 8, 2021

Related U.S. Application Data
(60) Provisional application No. 63/009,256, filed on Apr. 13, 2020.

(51) Int. Cl. F16H 3/14; F16D 41/18; F16H 3/10; F16H 3/089

(52) U.S. Cl. CPC F16H 3/14; F16D 41/185; F16H 2003/0822; F16H 3/089; F16H 3/10

(57) ABSTRACT

A partial reverse clutch assembly comprises a frame that mounts an input and output gears, a coupling member that couples the input and output gears, a swing body, and a lock gear. The coupling member engages with the swing body along a track of the coupling member. The swing body comprises radially inward tabs that slide along the track. The input gear drives the swing body, the coupling member, and the output gear in a first direction using a motorized rotational drive. The lock gear in engagement with the swing body prevents the swing body from rotating in a second direction that is opposite to the first direction. The swing body partially rotates in the second direction until the tabs of the swing body are raised along a ramp to section of the track that forces the coupling member to decouple from the output gear.

### CROSS REFERENCES TO RELATED APPLICATIONS

This application claims priority and benefit under 35 U.S.C. 119(e) from U.S. provisional application No. 63/009,256 titled “A Partial Reverse Clutch Assembly With An Annular Swing Body,” having a filing date of Apr. 13, 2020.

### BACKGROUND

### 1. Field of the Disclosure

The present disclosure relates generally to simultaneous operations in a printer that includes reversal of a photoconductor drum and a reversed duplex actuation of media using a clutch assembly and more particularly to a partial reverse clutch assembly.

### 2. Description of the Related Art

In current mono platforms, at the end of the printing cycle, the motor driving the photoconductor drum is reversed. This motor reversal allows the sharp edge of the elastic urethane cleaner blade to relax, which helps with localized fatiguing of the material. The motor reversal also allows the toner/EPAs to be backed out, which helps prevent accumulation that can cause localized cleaning failures. This helps photoconductor units reach their intended life. The reversal of the photoconductor drum is, for example, in the range of 15 to 18 degrees of motion. More motion than this may lead to undesirable outcomes, such as, toner contamination of the charge rolls.

In the current mid-range mono platforms, there is a single motor dedicated to the entire operation of the printer. In order to reverse the photoconductor drum, the main motor of the machine is reversed. This means that the reverse motion of the motor is entirely dedicated to the photoconductor reversal function. When considering duplex media present in the mid-range platform, it is necessary to reverse the motion of the media to send it back into the machine to be imaged again. Currently, this reversed motion is accomplished via a solenoid which is activated and moved along a swing arm in the gear train that changes the direction of a paper nip.

Thus, there is a need to allow the mid-range mono platform to use the reversal of the main motor to reverse the paper for the duplex operation while simultaneously preserving the reversing of the photoconductor drum a precise amount. Hence, an expensive solenoid is removed from the printer platform to save additional costs significantly.

### SUMMARY

A partial reverse clutch assembly disclosed here addresses the above mentioned need to allow the mid-range mono platform to use the reversal of the main motor to reverse the paper for the duplex operation while simultaneously preserving the reversing of the photoconductor drum by a precise amount. The partial reverse clutch assembly comprises a frame, an input gear, an output gear, a coupling member, an annular swing body, and a lock gear. The frame is configured to mount the input gear and the output gear. The coupling member is disposed between and coupling the input gear and the output gear, wherein the coupling member comprises a track along a circumferential surface of the coupling member. The coupling member is configured to be in engagement with an annular swing body along the track of the coupling member. The annular swing body is positioned between the input gear and the coupling member, wherein the annular swing body comprises radially inward tabs that are configured to slide along the track of the coupling member.

The input gear drives the annular swing body, the coupling member, and the output gear in a first direction using a motorized rotational drive. The lock gear is in engagement with the annular swing body, where the lock gear is configured to prevent the annular swing body from rotating in a second direction that is opposite to the first direction. Since the lock gear prevents the rotation of the annular swing body in the second direction, the annular swing body partially rotates in the second direction until the tabs of the annular swing body are raised along a ramp section of the track that forces the coupling member to decouple from the output gear. In an embodiment, the lock gear is engaged to a one way clutch that prevents the annular swing body from rotating in the second direction.

In an embodiment, the input gear comprises centrally positioned input tabs that are configured to engage with coupler tabs that are positioned at a bottom section of the coupling member. In an embodiment, the partial reverse clutch assembly further comprises top cams positioned on the coupling member. During the rotation of the output gear in the second direction, the top cams transfer torque to the output gear, and angled surfaces of the top cams generate a downward reaction force on the coupling member. In an embodiment, during the rotation of the annular swing body in the second direction, an upper section of the track provides continuous free rotation of the annular swing body. In an embodiment, the amount of reverse rotation before decoupling of the coupling member is determined via adjusting length of a lower section of the track.

In an embodiment, the reversal of the motorized rotational drive is configured to reverse a printing path of a printable media that is driven by the motorized rotational drive for a duplex operation of a printer. The reversal of the motorized rotational drive simultaneously partially rotates a photoconductor drum gear that is in geared engagement with the output gear due to partial rotation of the output gear in the second direction.

### BRIEF DESCRIPTION OF THE DRAWINGS

The accompanying drawings incorporated in and forming a part of the specification, illustrate several aspects of the present disclosure, and together with the description serve to explain the principles of the present disclosure.

FIG. 1 is an isometric view of the partial reverse clutch assembly, as an embodiment.

FIG. 2 is an exploded view of the partial reverse clutch assembly shown in FIG. 1, according to the embodiment.

FIG. 3A is an isometric view of the partial reverse clutch assembly when the coupling member is engaged, according to the embodiment.

FIG. 3B is a top perspective view of the partial reverse clutch assembly when the coupling member is engaged, according to the embodiment.

FIG. 3C is a sectional view of the partial reverse clutch assembly along the section A-A shown in FIG. 3B, when the coupling member is engaged, according to the embodiment.

FIG. 4A is an isometric view of the partial reverse clutch assembly when the coupling member is disengaged, according to the embodiment.

FIG. 4B is a side perspective view of the partial reverse clutch assembly when the coupling member is disengaged, according to the embodiment.

FIG. 4C is a sectional view of the partial reverse clutch assembly along the section B-B shown in FIG. 4B, when the coupling member is disengaged, according to the embodiment.

FIG. 5 is an isometric view of the input gear of the partial reverse clutch assembly, according to the embodiment.

FIG. 6A is bottom perspective view of the coupling member the partial reverse clutch assembly, according to the embodiment.

FIG. 6B is top perspective view of the coupling member the partial reverse clutch assembly, according to the embodiment.

FIG. 7 is top perspective view of the swing body of the partial reverse clutch assembly, according to the embodiment.

FIG. 8 is top perspective view of the lock gear of the partial reverse clutch assembly, according to the embodiment.

FIG. 9 is bottom perspective view of the retainer present in the frame of the partial reverse clutch assembly, according to the embodiment.

### DETAILED DESCRIPTION

In the following description, reference is made to the accompanying drawings where like numerals represent like elements. The embodiments are described in sufficient detail to enable those skilled in the art to practice the present disclosure. It is to be understood that other embodiments may be utilized and that process, electrical, and mechanical changes, etc., may be made without departing from the scope of the present disclosure. Examples merely typify possible variations. Portions and features of some embodiments may be included in or substituted for those of others. The following description, therefore, is not to be taken in a limiting sense and the scope of the present disclosure is defined only by the appended claims and their equivalents.

Also, it is to be understood that the phraseology and terminology used herein is for the purpose of description and should not be regarded as limiting. The use herein of “including,” “comprising,” or “having” and variations thereof is meant to encompass the items listed thereafter and equivalents thereof as well as additional items. Further, the terms “a” and “an” herein do not denote a limitation of quantity but rather denote the presence of at least one of the referenced item.

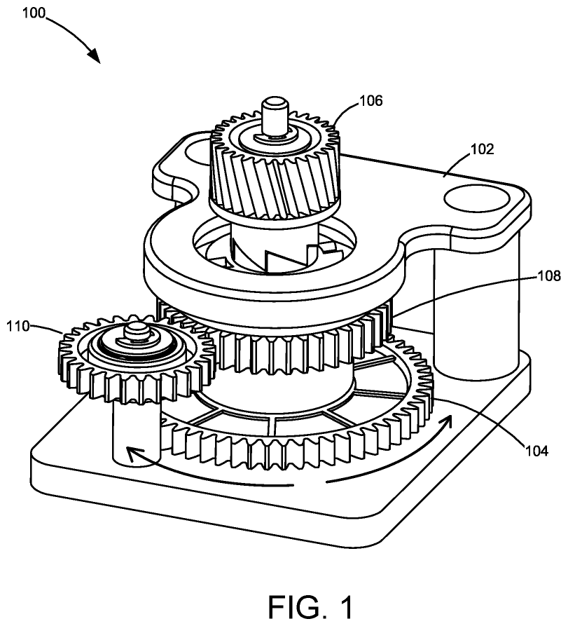

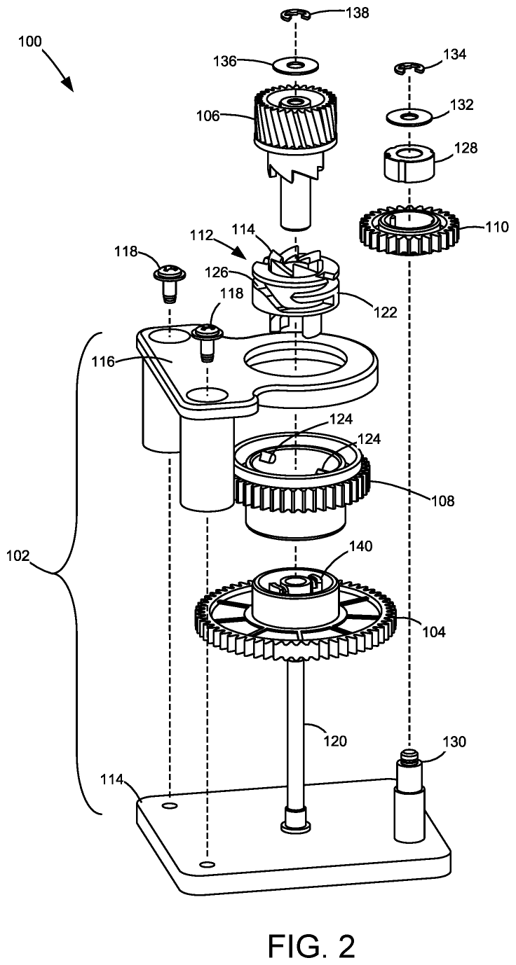

FIG. 1 is an isometric view of the partial reverse clutch assembly 100, as an embodiment. The frame 102 houses the input gear 104 and the output gear 106, and couples the input gear 104 and the output gear 106 via an annular swing body 108 and a coupling member 112, as shown in FIG. 2. The lock gear 110 is operatively engaged to the swing body 108 to lock the swing body 108 from rotating in a reverse direction, which is further explained in detail in the description of FIGS. 2-9.

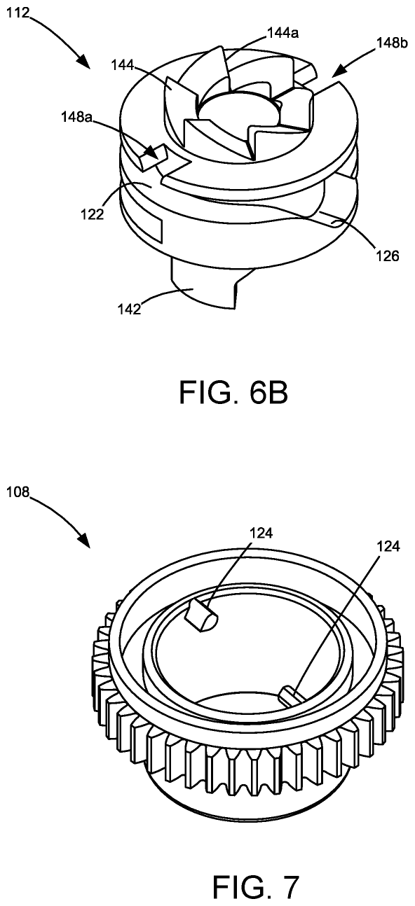

FIG. 2 is an exploded view of the partial reverse clutch assembly 100 shown in FIG. 1, according to the embodiment. The partial reverse clutch assembly 100 comprises the frame 102 or housing, the input gear 104, the output gear 106, the coupling member 112, the annular swing body 108, and the lock gear 110. Hereafter, the ‘coupling member 112’ will be referred to as ‘cam coupler 112’ and the ‘annular swing body 108’ will be referred to as ‘thrust gear 108’. The frame 102 mounts the input gear 104 and the output gear 106, on a lower section and an upper section of the frame 102 respectively. The frame 102, is an assembly of gear plate 114 and a retainer 116 that are connected to each other using fasteners 118. The input gear 104, the thrust gear 108, the cam coupler 112, and the output gear 106 are mounted on a shaft 120 that extends from the gear plate 114. The cam coupler 112 is disposed between and coupling the input gear 104 and the output gear 106, wherein the cam coupler 112 comprises a track 122 along a circumferential surface of the cam coupler 112, which is exemplarily illustrated in FIGS. 6A and 6B. The cam coupler 112 is configured to be in engagement with the thrust gear 108 along the track 122 of the cam coupler 112.

The thrust gear 108 is positioned between the input gear 104 and the cam coupler 112, wherein the thrust gear 108 comprises radially inward tabs 124 that are configured to slide along the track 122 of the cam coupler 112. The input gear 104 drives the thrust gear 108, the cam coupler 112, and the output gear 106 in a first direction using a motorized rotational drive. The output gear 106 is fastened using a washer 136 and a fastener 138. The lock gear 110 is in engagement with the thrust gear 108, where the lock gear 110 prevents the thrust gear 108 from rotating in a second direction that is opposite to the first direction. Since the lock gear 110 prevents the rotation of the thrust gear 108 in the second direction, the thrust gear 108 partially rotates in the second direction until the tabs 124 of the thrust gear 108 are raised along a ramp section 126 of the track 122 that forces the cam coupler 112 to decouple from the output gear 106. In an embodiment, the lock gear 110 is engaged to a one way clutch 128 that prevents the thrust gear 108 from rotating in the second direction. The one way clutch 128 is axially positioned within the lock gear 110 along a shaft 130 and fastened using a washer 132 and a fastener 134.

In an embodiment, the input gear 104 comprises centrally positioned input tabs 140 that are configured to engage with coupler tabs 142 positioned at a bottom section of the cam coupler 112. In an embodiment, the partial reverse clutch assembly 100 further comprises top cams 144 positioned on the cam coupler 112, where during the rotation of the output gear 106 in the second direction, the top cams 144 transfer torque to the output gear 106, and angled surfaces 144a of the top cams 144 generate a downward reaction force on the cam coupler 112. In an embodiment, during the rotation of the thrust gear 108 in the second direction, an upper section of the track 122 provides continuous free rotation of the thrust gear 108. In an example, the reversal of the motorized rotational drive is configured to reverse a printing path of a printable media that is driven by the motorized rotational drive for a duplex operation of a printer. The reversal of the motorized rotational drive simultaneously partially rotates a photoconductor drum gear that is in geared engagement with the output gear 106 due to partial rotation of the output gear in the second direction. This allows a mid-range mono platform to use the reversal of the main motor to reverse the paper for the duplex operation while simultaneously preserving the reversing of the photoconductor drum by a precise amount.

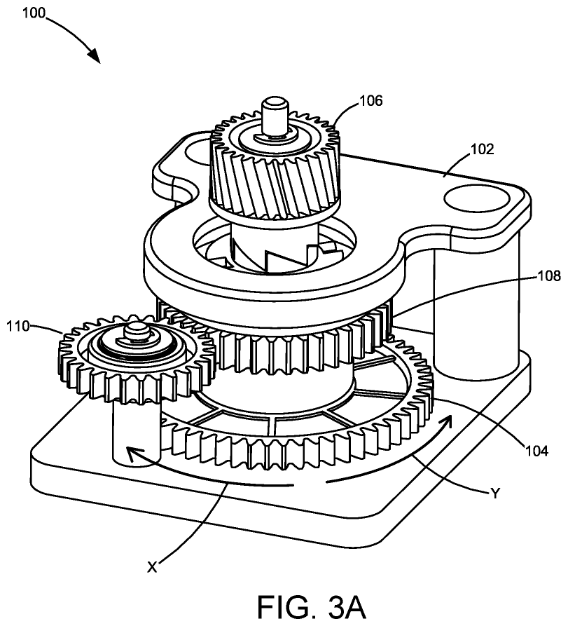

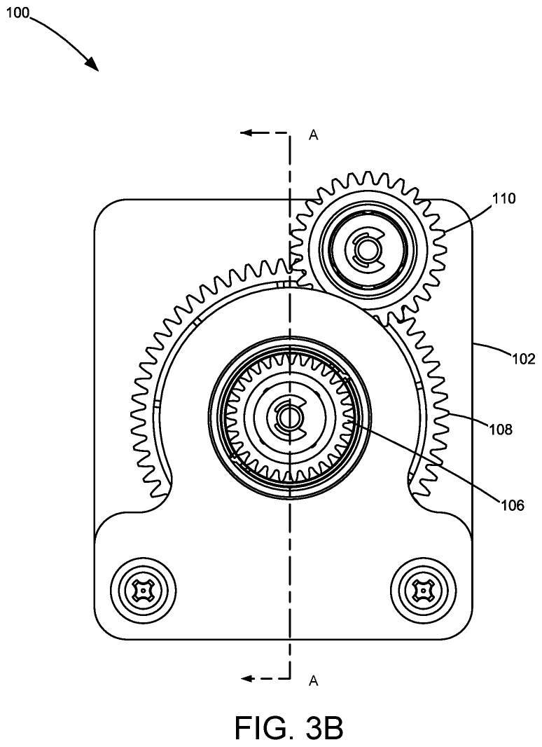

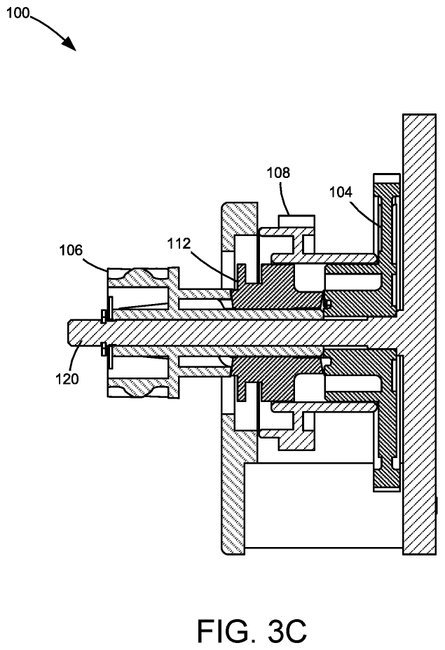

FIGS. 3A-3C show an isometric view, a top perspective view, and a sectional view respectively, of the partial reverse clutch assembly 100 when the cam coupler 112 is engaged, according to the embodiment. As described in FIG. 2, the input gear 104 drives the thrust gear 108, the cam coupler 112, and the output gear 106 in a first direction, as denoted by the arrow X shown in FIG. 3A, along the shaft 120 using a motorized rotational drive. The lock gear 110 is also in engagement with the thrust gear 108 and allows rotation of the assembly comprising the input gear 104, the thrust gear 108, the cam coupler 112, and the output gear 106 in the first direction. During this first direction of rotation, the cam coupler 112 is in a raised position, and the inner tabs 124 of the thrust gear 108 are at a lower section 122b of the track 122, as shown in FIGS. 6A and 6B. This causes the thrust gear 108 to be rotated along with the cam coupler 112 because tabs 124 of the thrust gear 108 will rest against the end portion of the lower level 122b of the track 122, which is explained in the description of cam coupler 112 in FIGS. 6A and 6B.

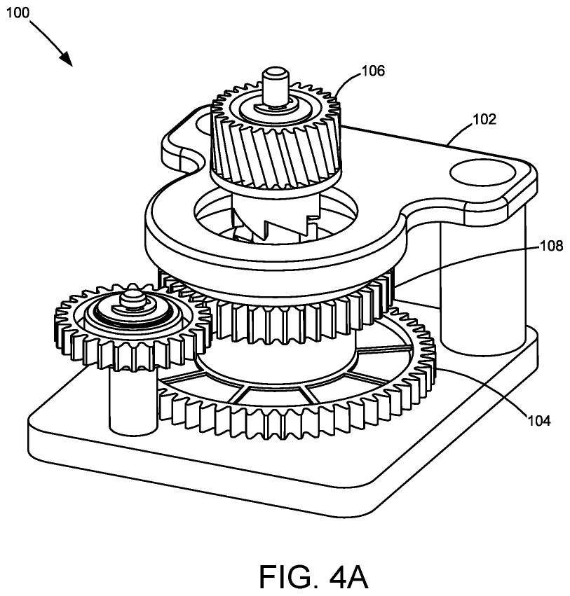

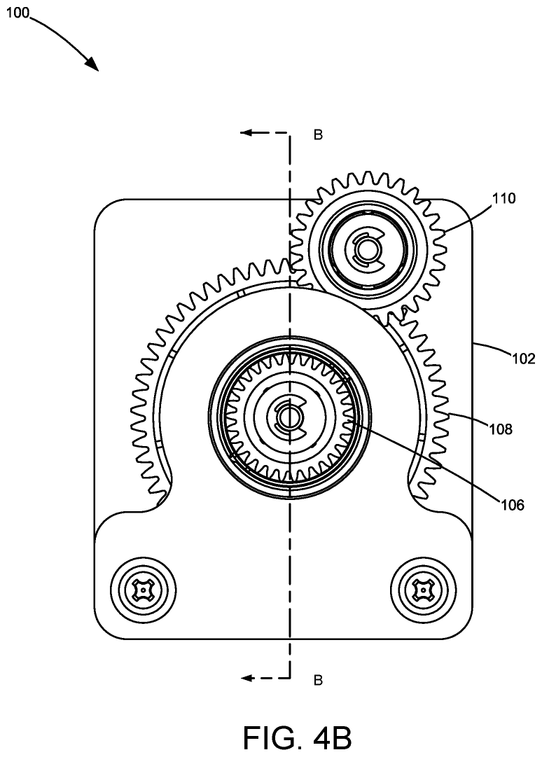

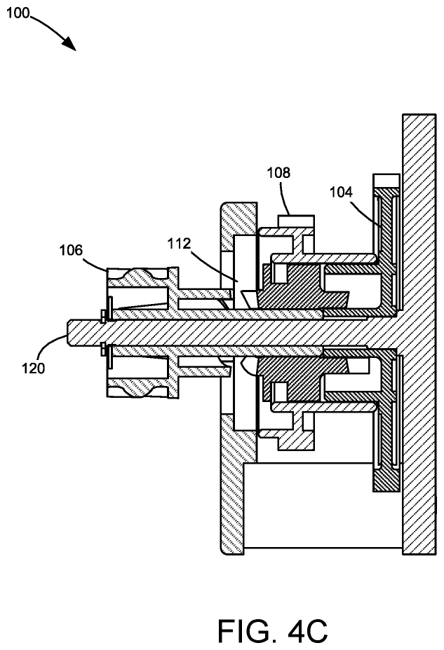

FIGS. 4A-4C show an isometric view, a top perspective view, and a sectional view respectively, of the partial reverse clutch assembly 100 when the cam coupler 112 is disengaged, according to the embodiment. As explained in the description of FIG. 2, the lock gear 110 is in engagement with the thrust gear 108 and prevents the thrust gear 108 from rotating in the second direction that is opposite to the first direction, in other words a reverse direction as denoted by the arrow Y shown in FIG. 3A. When rotation in the reverse direction begins, the top cams 144 of the cam coupler 112 continuously transfer torque to the output gear 106. However, the angled surfaces 144a of the cam coupler 112 create a downward reaction force on the cam coupler 112 that eventually decouples the cam coupler 112 from the output gear 106, which is explained in the description of FIGS. 6A and 6B. Furthermore, the lock gear 110 prevents the rotation of the thrust gear 108 in the reverse direction and the thrust gear 108 partially rotates in the reverse direction until the tabs 124 of the thrust gear 108 are raised along a ramp section 126 of the track 122 that forces the cam coupler 112 to decouple from the output gear 106.

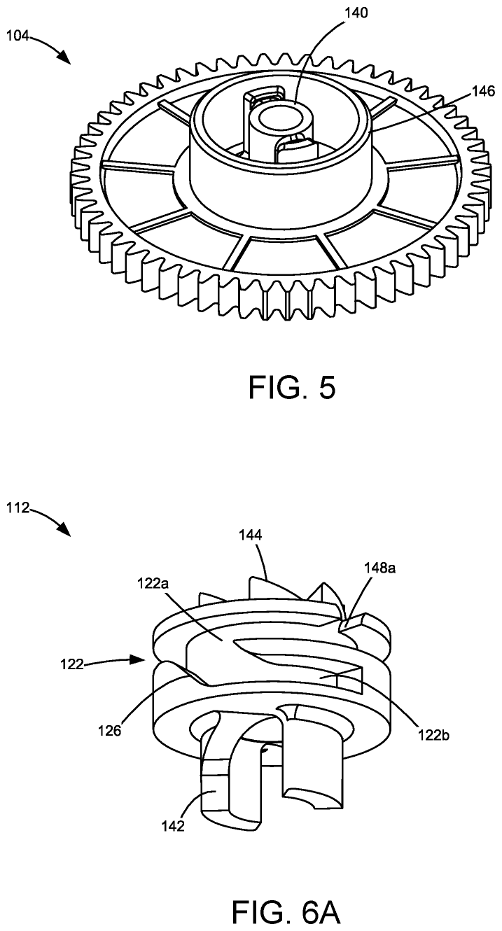

FIG. 5 is an isometric view of the input gear 104 of the partial reverse clutch assembly 100, according to the embodiment. The input tabs 140 that are positioned on a top middle portion or a hub portion 146 of the input gear 104 and exerts an upward force on the cam coupler 112, using the bottom cams or coupler tabs 142 of the cam coupler 112, toward the output gear 106 when the input gear 104 is turning in the forward or the first direction. The upward force that is provided on the cam coupler 112 keeps the cam coupler 112 in engagement with the output gear 106 during the rotation in the first direction.

FIGS. 6A and 6B show a bottom perspective view and a top perspective view of the cam coupler 112 the partial reverse clutch assembly 100, according to the embodiment. In an embodiment, the cam coupler 112 has two vertical home positions corresponding with the two levels of the track 122 running around its perimeter and the cam coupler 112 always rotates with the input gear 104. During forward rotation, the cam coupler 112 is in an upper section 122a of the track 122, and the inner posts or tabs 124 of the thrust gear 108 are in the lower section 122b of the track 122. The thrust gear 108 is rotated with the cam coupler 112 because the tabs 124 of the thrust gear 108 are contacting the ends of the lower section 122b of the track 122. When rotation in the reverse direction begins, the top cams 144 of the cam coupler 112 continue transferring torque to the output gear 106 to turn the output gear 106, but the angled surfaces 144a on the top cams 144 of the cam coupler 112 create a downward reaction force on the cam coupler 112. The top edge of the lower section 122b of the track 122 prevents the cam coupler 112 from being disengaged for a period.

Eventually, the posts or the tabs 124 of the thrust gear 108 contact the ramp section 126 that is present on the track 122. The thrust gear 108 is prevented from rotating in this direction by the lock gear 110, so the tabs 124 slide along the ramp section 126 and pulls the cam coupler 112 out of engagement. The tabs 124 of the thrust gear 108 then allow continuous free rotation of the cam coupler 112 because the upper section 122a of the track 122 is continuous in construction, as shown in FIG. 6A. When rotation of the forward direction is reinstated, the input gear 104 exerts an upward force on the cam coupler 112 and turns it until the tabs 124 of the thrust gear 108 reach the ramp section 126 on the track 122 of the cam coupler 112.

Thereafter, the cam coupler 112 returns into engagement with the output gear 106. Eventually, the tabs 124 of the thrust gear 108 reach the ends of the lower level 122b of the track 122 and the thrust gear 108 is forced to rotate with the cam coupler 112. Hence, the lock gear 110 is able to freely rotate in this forward direction without resistance from the one way clutch 128, which is shown in FIG. 2. The two notches 148 a and 148b, as shown in FIG. 6B, on the top surface of the cam coupler 112 are for assembly and allow the cam coupler 112 to be inserted into the thrust gear 108 from below. The amount of reverse rotation transferred to the output gear 106 before disengagement is directly controlled by adjusting the length of the lower section 122b of the track 122 of the cam coupler 112. In an embodiment, the amount of reverse rotation before decoupling of the cam coupler 112 from the output gear 106 is determined via adjusting length of a lower section 122a of the track 122, as shown in FIGS. 6A and 6B.

FIG. 7 is top perspective view of the thrust gear 108 of the partial reverse clutch assembly 100, according to the embodiment. The thrust gear 108 is designed to force the cam coupler 112 out of engagement when rotating in the reverse direction. When the reverse rotation begins, the one-way clutch 128 of the lock gear 110 prevents the thrust gear 108 from rotating in the reverse direction. This causes the tabs 124 of the thrust gear 108 to ride along the lower level 122b of the track 122 of the cam coupler 112 until it reaches the ramp section 126 in the track 122 and forcefully cams the cam coupler 112 out of engagement with the output gear 106. Without the thrust gear 108, the lower interface of the output gear 106 with the cam coupler 112 would cam the cam coupler 112 away but allow sporadic contact that transfers some torque and allow the cam coupler 112 to turn.

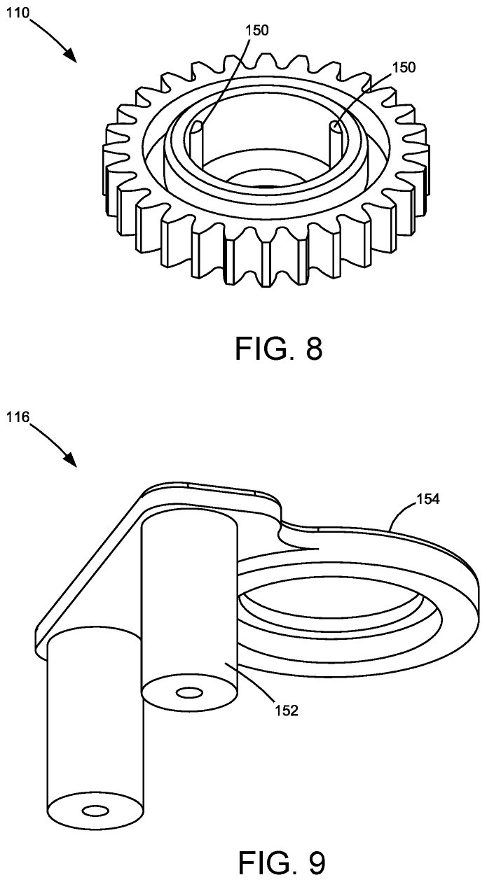

FIG. 8 is top perspective view of the lock gear 110 of the partial reverse clutch assembly 100, according to the embodiment. The lock gear 110 is connected to a one-way clutch 128 that is shown in FIG. 2. The lock gear 110 is implemented here as, for example, a self-contained off-the-shelf component. The lock gear 110 also includes engagement portions 150 that are configured to receive and engage with the one way clutch 128. The one-way clutch 128 only allows the lock gear 110 to rotate in the first direction that is opposite to the second or reverse direction of rotation of the input gear 104.

FIG. 9 is bottom perspective view of the retainer 116 present in the frame 102 of the partial reverse clutch assembly 100, according to the embodiment. The retainer 116 along with the gear plate 114 as shown in FIG. 2, defines the frame 102 of the partial reverse clutch assembly 100. The retainer 116 comprises columns 152 that are fastened to the gear plate 114 and an annular section 154 that are configured to mount and align the assembly comprising the input gear 104, the output gear 106, the cam coupler 112, the thrust gear 108, and the lock gear 110. The retainer 116 also prevents the thrust gear 108 from moving axially away from the input gear 104.

Based on the embodiment of the partial reverse clutch assembly 100, in the forward or first direction the input gear 104 and output gear 106 are driven in a normal manner. However, once the rotation of the input gear 104 is reversed, the output gear 106 drive for a predetermined amount of rotation. In an example, the partial reverse clutch assembly 100 is adjusted between 10 to 180 degrees of output fairly easily. Once the desired amount of reversing motion is achieved, the output gear 106 is decoupled which allows the input gear 104 to freely spin and the output gear 106 is maintained in an idle state until the forward direction is engaged once again.

The foregoing description of several methods and an embodiment of the present disclosure have been presented for purposes of illustration. It is not intended to be exhaustive or to limit the present disclosure to the precise steps and/or forms disclosed, and obviously many modifications and variations are possible in light of the above description. It is intended that the scope of the present disclosure be defined by the claims appended hereto.

We claim:

1. A partial reverse clutch assembly, comprising:
a frame configured to mount an input gear and an output gear;
a coupling member disposed between and coupling the input gear and the output gear, wherein the coupling member comprises a track along a circumferential surface of the coupling member, and wherein the coupling member is configured to be in engagement with an annular swing body along the track of the coupling member;
the annular swing body positioned between the input gear and the coupling member, wherein the annular swing body comprises radially inward tabs that are configured to slide along the track of the coupling member, wherein the input gear drives the annular swing body, the coupling member, and the output gear in a first direction using a motorized rotational drive; and
a lock gear in engagement with the annular swing body, wherein the lock gear is configured to prevent the annular swing body from rotating in a second direction that is opposite to the first direction, wherein the annular swing body partially rotates in the second direction until the tabs of the annular swing body are raised along a ramp section of the track that forces the coupling member to decouple from the output gear.

2. The partial reverse clutch assembly of claim 1, wherein the lock gear is engaged to a one way clutch that prevents the annular swing body from rotating in the second direction.

3. The partial reverse clutch assembly of claim 1, wherein the input gear comprises centrally positioned input tabs that are configured to engage with coupler tabs positioned at a bottom section of the coupling member.

4. The partial reverse clutch assembly of claim 1, further comprising top cams positioned on the coupling member, wherein during the rotation of the output gear in the second direction, the top cams transfer torque to the output gear.

5. The partial reverse clutch assembly of claim 4, further comprising angled surfaces of the top cams of the coupling member that are configured to generate a downward reaction force on the coupling member to decouple the coupling member from the output gear.

6. The partial reverse clutch assembly of claim 1, wherein during the rotation of the annular swing body in the second direction, an upper section of the track provides continuous free rotation of the annular swing body.

7. The partial reverse clutch assembly of claim 1, wherein the amount of reverse rotation before decoupling of the coupling member is determined via adjusting length of a lower section of the track.

8. The partial reverse clutch assembly of claim 1, wherein the reversal of the motorized rotational drive is configured to reverse a printing path of a printable media that is driven by the motorized rotational drive for a duplex operation of a printer.

9. The partial reverse clutch assembly of claim 8, wherein the reversal of the motorized rotational drive simultaneously partially rotates a photoconductor drum gear that is in geared engagement with the output gear due to partial rotation of the output gear in the second direction.

10. A method for partially rotating an output gear in a reverse direction and decoupling the output gear from an input gear after the partial rotation of the output gear, the method comprising:
providing partial reverse clutch assembly comprising:
a frame configured to mount the input gear and the output gear;
a coupling member disposed between and coupling the input gear and the output gear, wherein the coupling member comprises a track along a circumferential surface of the coupling member, and wherein the coupling member is configured to be in engagement with an annular swing body along the track of the coupling member;
the annular swing body positioned between the input gear and the coupling member, wherein the annular swing body comprises radially inward tabs that are configured to slide along the track of the coupling member; and
a lock gear in engagement with the annular swing body;
driving the annular swing body, the coupling member, and the output gear in a first direction using a motorized rotational drive on the input gear;
partially rotating the annular swing body in the second direction until the tabs of the annular swing body are raised along a ramp section of the track that forces the coupling member to decouple from the output gear; and
preventing the annular swing body from rotating in a second direction that is opposite to the first direction using the lock gear.

11. The method of claim 10, wherein the lock gear is engaged to a one way clutch that prevents the annular swing body from rotating in the second direction.

12. The method of claim 10, wherein the input gear comprises centrally positioned input tabs that are configured to engage with coupler tabs positioned at a bottom section of the coupling member.

13. The method of claim 10, further comprising transferring torque to the output gear during the rotation in the second direction via top cams positioned on the coupling member.

14. The method of claim 13, further comprising generating a downward reaction force on the coupling member to decouple the coupling member from the output gear using angled surfaces positioned on the top cams of the coupling member.

15. The method of claim 10, wherein during the rotation of the annular swing body in the second direction, an upper section of the track provides continuous free rotation of the annular swing body.

16. The method of claim 10, further comprising adjusting length of a lower section of the track to determine the amount of reverse rotation before decoupling of the coupling member

17. The method of claim 10, wherein the reversal of the motorized rotational drive is configured to reverse a printing path of a printable media that is driven by the motorized rotational drive for a duplex operation of a printer.

18. The method of claim 17, wherein the reversal of the motorized rotational drive simultaneously partially rotates a photoconductor drum gear that is in geared engagement with the output gear due to partial rotation of the output gear in the second direction.
